(19) United States
(12) Patent Application Publication
(10) Pub. No.: US 2026/0133058 A1
(43) Pub. Date: May 14, 2026

(54) NON-CONTACT CONDUCTIVE FLUID FLOW METER

(71) Applicant: GM Global Technology Operations LLC, Detroit, MI (US)

(72) Inventors: Alireza Fatemi, Canton, MI (US); Thomas W. Nehl, Shelby Twp., MI (US); Wesley Gerard Zanardelli, Rochester, MI (US); Jun-mo Kang, Ann Arbor, MI (US); Andrew Clay Bobel, Troy, MI (US); John Patrick Spicer, Plymouth, MI (US)

(73) Assignee: GM Global Technology Operations LLC, Detroit, MI (US)

(21) Appl. No.: 18/948,082

(22) Filed: Nov. 14, 2024

(51) Int. Cl. G01F 1/58

(52) U.S. Cl. CPC G01F 1/582

(57) ABSTRACT

With a conductive fluid flowing through a conduit formed from a non-magnetic material, and with a flow meter positioned at or near the conduit and having a magnetic field source spaced from the conduit and producing a first magnetic field that at least partially interacts with the conductive fluid flowing through the conduit, a method includes generating sensor data representative of strength of a second magnetic field that at least partially interacts with the flow meter. The second magnetic field is produced by eddy currents induced in the conductive fluid by the first magnetic field. Based on processing of the generated sensor data representative of strength of the second magnetic field, the method includes determining a flow rate of the conductive fluid through the conduit.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to systems and methods for measuring a flow rate of a conductive fluid through a conduit using a contactless flow meter.

Many systems that carry conductive fluids, such as molten aluminum or alkali metals, through a conduit require accurate flow rate measurements of the conductive fluid through the conduit. For example, a launder system that delivers molten metal to a casting mold may utilize the flow rate measurement to control flow of the molten metal to the casting mold. Some common flow meters for measuring the flow rate of a conductive fluid utilize a probe that extends at least partially into the conduit carrying the conductive fluid. Other typical examples include a duct inline with the conduit, where electromagnetic coils form a magnetic field at the conduit and electrodes in contact with the duct measure voltage induced in the conductive fluid between the electrodes. Thus, these examples involve direct contact between the flow meter and the conductive fluid and/or the conduit carrying the conductive fluid, and thus require the flow meter to withstand high temperatures of the conductive fluid. Further, these examples include a break in the conduit and/or interfere with the flow of conductive fluid through the conduit. This can lead to leaks and other inefficiencies of the system delivering and/or receiving the conductive fluid from the conduit.

### SUMMARY

An aspect of the disclosure provides a computer-implemented method that, when executed on data processing hardware, causes the data processing hardware to perform operations. With a conductive fluid flowing through a conduit formed from a non-magnetic material, and with a flow meter positioned at or near the conduit and having a magnetic field source spaced from the conduit and producing a first magnetic field that at least partially interacts with the conductive fluid flowing through the conduit, the operations include generating sensor data representative of strength of a second magnetic field that at least partially interacts with the flow meter. The second magnetic field is produced by eddy currents induced in the conductive fluid by the first magnetic field. Based on processing of the generated sensor data representative of strength of the second magnetic field, the operations include determining a flow rate of the conductive fluid through the conduit.

Implementations of the disclosure may include one or more of the following optional features. In some implementations, the magnetic field source further includes a housing and a biasing element between the magnetic field source and the housing. The second magnetic field causes movement of the magnetic field source toward the biasing element and the housing. A linear displacement sensor generates the sensor data representative of strength of the second magnetic field based on movement of the magnetic field source relative to the biasing element and the housing.

In some examples, an array of load sensors engaging the magnetic field source generate the sensor data representative of strength of the second magnetic field. In some aspects, the magnetic field source includes a permanent magnet.

In some implementations, the magnetic field source includes an electromagnet. In further implementations, the electromagnet includes a first wire coil and a second wire coil. The first wire coil is electrically charged to produce the first magnetic field. The second magnetic field induces current in the second wire coil. The sensor data representative of strength of the second magnetic field is generated based on the current induced in the second wire coil. In some further implementations, the operations further include electrically charging the electromagnet to produce the first magnetic field. Electrically charging the electromagnet may include using DC electrical current and/or using AC electrical current.

In some examples, the operations further include determining a calibration profile based on processing of the generated sensor data representative of strength of the second magnetic field and known flow rates of the conductive fluid through the conduit. In some aspects, the conductive fluid includes molten aluminum. The conduit delivers the conductive fluid to a casting mold for a vehicular component.

Another aspect of the disclosure provides a system. The system includes a flow meter positioned at or near a conduit formed from a non-magnetic material. The flow meter includes a magnetic field source. The system includes data processing hardware and memory hardware in communication with the data processing hardware. The memory hardware stores instructions that, when executed on the data processing hardware, cause the data processing hardware to perform operations. With a conductive fluid flowing through the conduit, and with the magnetic field source spaced from the conduit and producing a first magnetic field that at least partially interacts with the conductive fluid flowing through the conduit, the operations include generating sensor data representative of strength of a second magnetic field that at least partially interacts with the flow meter. The second magnetic field is produced by eddy currents induced in the conductive fluid by the first magnetic field. Based on processing of the generated sensor data representative of strength of the second magnetic field, the operations include determining a flow rate of the conductive fluid through the conduit. This aspect may include one or more of the following optional features.

In some implementations, the magnetic field source further includes a housing and a biasing element between the magnetic field source and the housing. The second magnetic field causes movement of the magnetic field source toward the biasing element and the housing. A linear displacement sensor generates the sensor data representative of strength of the second magnetic field based on movement of the magnetic field source relative to the biasing element and the housing.

In some examples, an array of load sensors engaging the magnetic field source generate the sensor data representative of strength of the second magnetic field. In some aspects, the magnetic field source includes a permanent magnet.

In some implementations, the magnetic field source includes an electromagnet. In further implementations, the electromagnet includes a first wire coil and a second wire coil. The first wire coil is electrically charged to produce the first magnetic field. The second magnetic field induces current in the second wire coil. The sensor data representative of strength of the second magnetic field is generated based on the current induced in the second wire coil. In some further implementations, the operations further include electrically charging the electromagnet to produce the first magnetic field. Electrically charging the electromagnet may include using DC electrical current and/or using AC electrical current.

In some examples, the operations further include determining a calibration profile based on processing of the generated sensor data representative of strength of the second magnetic field and known flow rates of the conductive fluid through the conduit. In some aspects, the conductive fluid includes molten aluminum. The conduit delivers the conductive fluid to a casting mold for a vehicular component.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle having a component formed via a casting process.

FIG. 2 is a schematic diagram of a contactless flow meter disposed at a conduit of a foundry system for determining a flow rate of conductive fluid through the conduit.

FIG. 3 is a schematic diagram of a sensor of the flow meter configured to sense linear displacement of a magnetic field source of the flow meter.

FIG. 4 is a schematic diagram of a horseshoe-shaped magnetic field source of the flow meter.

FIG. 5 is a schematic diagram of an electromagnet of the flow meter circumscribing the conduit.

FIG. 6 is a flow diagram of an example method for determining the flow rate of the conductive fluid through the conduit based on sensor data captured by the contactless flow meter.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

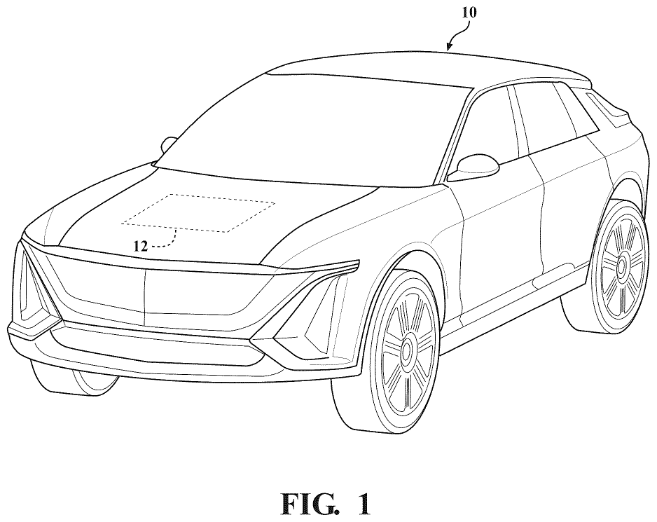

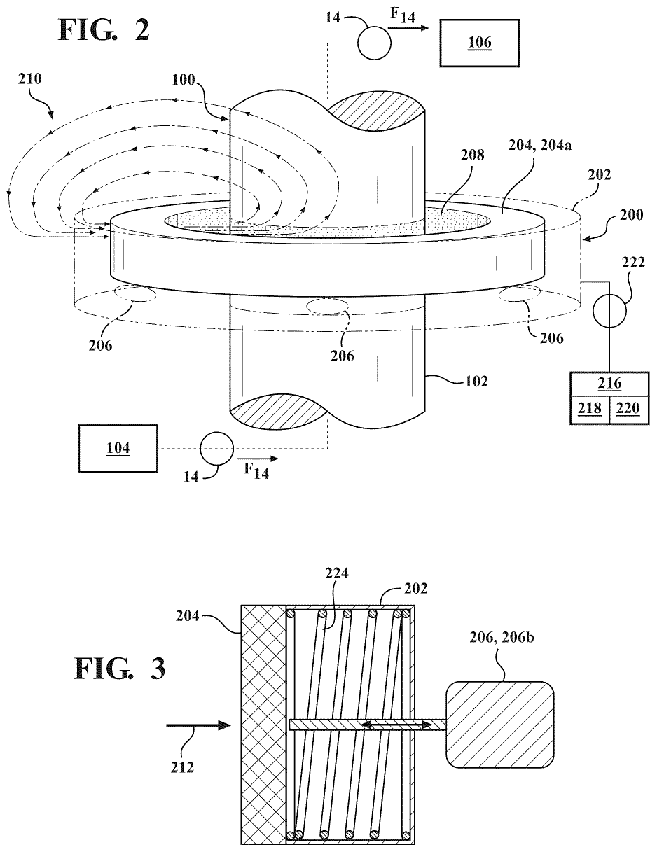

Referring now to the figures and the illustrated configurations depicted therein, a vehicle 10 includes one or more components formed via a metallic casting process (FIG. 1). For example, the vehicle 10 includes an engine block 12 formed from cast aluminum. That is, the engine block 12 (or one or more other components of the vehicle 10) is formed by dispensing molten aluminum 14 into a mold using conventional casting techniques. Aspects of the casting process may rely on real time flow rate measurements of the molten aluminum 14 through one or more conduits 102, such as when the molten aluminum is drawn from a reservoir 104 and delivered to the casting mold 106 via conduits 102 of a foundry system 100 (FIG. 2). As described further below, a contactless or non-contact flow meter 200 is configured to reliably determine the flow rate of the molten aluminum 14 through the conduit 102 without directly engaging the molten aluminum 14 and/or the conduit 102 and without interrupting or segmenting the conduit 102 between the reservoir 104 and the casting mold 106. Although described herein as determining the flow rate of molten aluminum 14 through the conduit 102 of the foundry system 100, it should be understood that the flow meter 200 may be configured to determine flow rates of any suitable conductive fluid, such as alkali metals or charged chemical solutions, through conduits of various systems.

As shown in FIG. 2, the flow meter 200 includes a housing 202 that accommodates a magnetic field source 204 and one or more sensors 206. The illustrated example shows an array of sensors 206 disposed within the housing 202. The housing 202 includes an opening or a channel or a passageway through the flow meter 200 and the conduit 102 passes through the opening. Likewise, the magnetic field source 204 generally corresponds to the shape of the housing 202 and extends within the housing 202 to wrap around or substantially circumscribe the conduit 102. Although shown as a continuous ring or disc surrounding the conduit 102, the housing 202 and the magnetic field source 204 may include two or more separate or separable sections or sides that cooperate to surround the conduit 102. Optionally, a heat shield 208 including a layer of thermally insulating material may be disposed between the conduit 102 and the housing 202 and/or magnetic field source 204 of the flow meter 200 to reduce or prevent thermal transfer between the conduit 102 and the flow meter 200.

The conduit 102 is formed from a non-magnetic material, such as a non-ferrous material, a magnetically non-permeable metal like tungsten or tungsten-coated stainless steel (e.g., SAE 304 or SAE 306), or a non-metallic ceramic material. Thus, with the molten aluminum 14 flowing through the conduit 102, and with the flow meter 200 positioned at or near the conduit 102, a first magnetic field 210 produced by the magnetic field source 204 may at least partially pass through the conduit 102 to interact with the molten aluminum 14 flowing therethrough.

As shown in FIG. 2, magnetic flux lines representing the magnetic field 210 cross the interior channel of the conduit 102 and thus the magnetic field 210 at least partially crosses and interacts with the molten aluminum 14. In some examples, the magnetic field 210 may be oriented substantially perpendicular to a direction of flow of the molten aluminum 14 through the conduit 102 (e.g., parallel to a longitudinal axis of the conduit 102) (FIG. 2). Optionally, the magnetic field 210 may be oriented substantially parallel to the direction of flow of the molten aluminum 14 through the conduit 102 (FIG. 5). As the molten aluminum 14 passes through the magnetic field 210, the magnetic field 210 induces eddy currents in the conductive molten aluminum 14. These eddy currents produce a reaction force via a second magnetic field 212 that opposes the first magnetic field 210 (FIG. 3). As discussed further below, when the second magnetic field 212 interacts with the magnetic field source 204, the flow meter 200 generates sensor data 222 that is representative of the strength of the second magnetic field 212 and a flow rate F₁₄ of the molten aluminum 14 through the conduit 102 can be determined based on the detected strength of the second magnetic field 212.

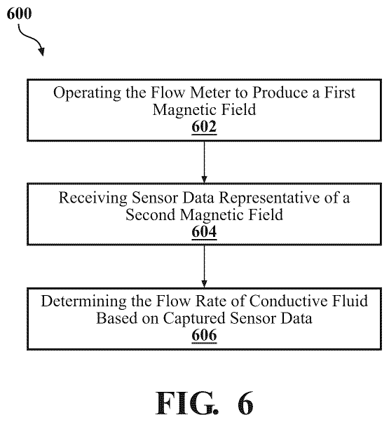

The flow meter 200 may include or be in communication with a control module 216 that includes data processing hardware 218 and memory hardware 220 in communication with the data processing hardware 218. The memory hardware 220 stores instructions that, when executed on the data processing hardware 218, cause the data processing hardware 218 to perform operations. For example, the control module 216 stores instructions for operating the flow meter 200 to determine the flow rate F₁₄ of the molten aluminum 14 based on the strength of the second magnetic field 212, such as according to the method 600 of FIG. 6 discussed further below.

In the illustrated example of FIG. 2, the magnetic field source 204 includes a permanent magnet, and more specifically an annular or ring-shaped magnet 204, 204a that circumscribes the conduit 102. To produce the magnetic field 210 generally perpendicular to the direction of flow of molten aluminum 14 through the conduit 102, the ring-shaped magnet 204a may have its poles radially oriented. That is, one pole of the magnet 204a may be disposed radially inboard of the other pole of the magnet 204a to produce the magnetic field 210 that extends through the conduit 102 and at least partially interacts with the molten aluminum 14 in a direction that is generally perpendicular to the flow of the molten aluminum 14. To produce the magnetic field 210 generally parallel to the direction of flow of molten aluminum 14 through the conduit 102, the ring-shaped magnet 204a may have its poles axially oriented. That is, one pole of the magnet 204a may be disposed adjacent to the other pole of the magnet 204a in a direction parallel to the longitudinal axis of the conduit 102 to produce the magnetic field 210 that extends through the conduit 102 and at least partially interacts with the molten aluminum 14 in a direction that is generally parallel to the flow of the molten aluminum 14. Thus, eddy currents are induced in the molten aluminum 14 to produce the second magnetic field 212.

Interaction between the second magnetic field 212 and the magnetic field source 204 applies the reaction force at the magnetic field source 204 which is then sensed by the array of sensors 206 disposed between the magnetic field source 204 and the housing 202. In FIG. 2, the sensors 206 include an array of load sensors 206, 206a configured to detect the force applied at the magnetic field source 204. The array of load sensors 206a may uniformly transfer the force experienced at the magnetic field source 204 to the housing 202. Responsive to detecting the force at the sensors 206, sensor data 222 captured by the sensors 206 and representative of the strength of the second magnetic field 212 is transferred to the control module 216 for processing. As discussed further below, the control module 216 may be calibrated to determine the flow rate F₁₄ of the molten aluminum 14 based on the measured force of the captured sensor data 222.

Referring to FIG. 3, a biasing element 224, such as a coil spring or wave spring, is disposed between the magnetic field source 204 and the housing 202 and the sensors 206 include one or more linear displacement sensors 206, 206b or electronic precision displacement measurement devices or linear variable differential transformers (LVDTs) configured to sense movement of the magnetic field source 204 relative to the housing 202. In other words, as the second magnetic field 212 interacts with the magnetic field source 204, the magnetic field source 204 may move against the biasing force of the biasing element 224 toward the inner surface of the housing 202 and the linear displacement sensors 206b generate sensor data 222 representative of the strength of the second magnetic field 212 based on the amount of linear movement of the magnetic field source 204. The control module 216 may be calibrated to determine the flow rate F₁₄ of the molten aluminum 14 based on the measured linear displacement of the captured sensor data 222.

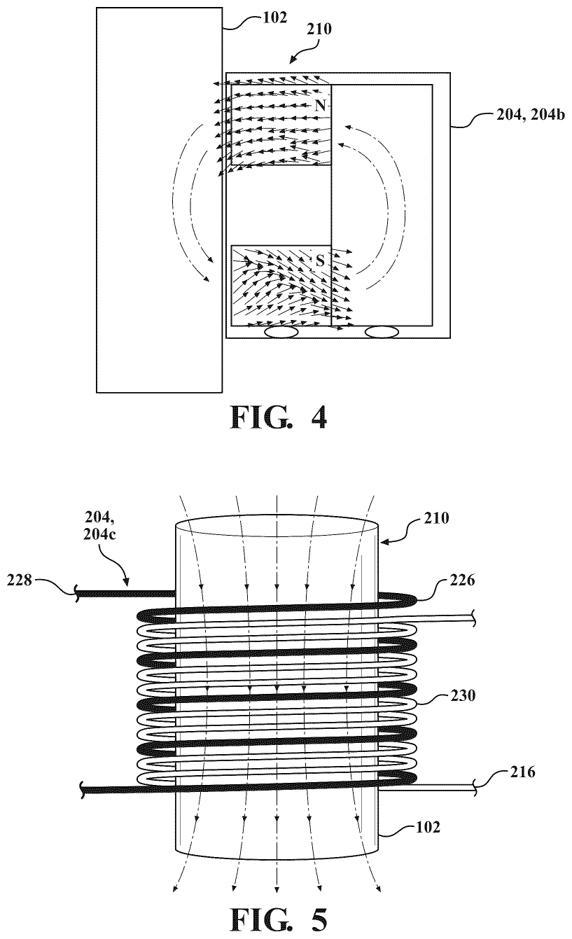

Thus, the flow meter 200 is configured to determine the flow rate F₁₄ of the molten aluminum 14 based on the strength of the reaction magnetic field 212 produced by eddy currents induced in the molten aluminum 14 by the primary magnetic field 210 produced by the magnetic field source 204. In FIG. 2, the magnetic field source 204 includes an annular permanent magnet 204a. Other suitable permanent magnets may be used to produce the magnetic field 210 that at least partially interacts with the molten aluminum 14. For example, FIG. 4 shows a horseshoe or U-shaped magnet 204, 204b having its poles disposed along a side of the conduit 102 and axially spaced from one another. The sensor 206 thus captures sensor data 222 representative of the strength of the second magnetic field 212 (e.g., based on force experienced at the magnetic field source 204 or based on displacement of the magnetic field source 204) and the sensor data 222 is processed to determine the flow rate F₁₄.

In some examples, and in reference to FIG. 5, the magnetic field source 204 may include an electromagnet 204, 204c having one or more wire coils circumscribing (and optionally spaced from) the conduit 102. In the illustrated example, the electromagnet 204c includes a first wire coil 226 having a plurality of turns circumscribing the conduit 102 and electrically connected to a power source 228. A second wire coil 230 having a plurality of turns circumscribing the conduit 102 may be electrically connected to the control module 216.

When the electromagnet 204c is operated to measure the flow of molten aluminum 14 through the conduit 102, the power source 228 electrically charges the first wire coil 226 to produce the magnetic field 210. As shown, the magnetic field 210 may be generally parallel to the flow direction of the molten aluminum 14. The eddy currents induced in the molten aluminum 14 generate the second magnetic field 212 and the second magnetic field 212 induces current in the second wire coil 230. Voltage at the second wire coil 230, as measured at the control module 216 may be indicative of the flow rate F₁₄ of the molten aluminum 14. In other words, the sensor data 222 generated may be representative of the strength of the second magnetic field 212 and based on the voltage at the second wire coil 230.

The power source 228 may electrically charge the first wire coil 226 with DC electrical current to mimic a permanent magnet. That is, the electromagnet 204c powered via DC electrical current may produce a steady or substantially constant magnetic field 210. Optionally, the power source 228 may electrically charge the first wire coil 226 with AC electrical current to boost the penetration depth of eddy currents in the molten aluminum 14. That is the first wire coil 226 may be actuated with AC current with sufficiently low frequency such that eddy currents penetrate deep enough into the flow of the molten aluminum 14. The turns ratio between the first and secondary coils may be used to amplify the induced voltage.

The control module 216 may be calibrated to determine the flow rate F₁₄ of the molten aluminum 14 based on sensor data 222 captured during a calibration session. For example, the control module 216 may be calibrated based on a known temperature of the molten aluminum 14, the diameter of the conduit 102, an expected flow rate of molten aluminum 14 from the reservoir 104, a current applied to the electromagnet 204c, and the like. Optionally, the flow meter 200 may include multiple magnetic field sources with varying levels of sensitivity to capture a range of flow rates.

FIG. 6 provides a flowchart of an exemplary arrangement of operations for a method 600 of determining the flow rate F₁₄ of the conductive fluid 14 through the conduit 102 using the contactless flow meter 200. The method 600 may be executed by the control module 216, such as at the data processing hardware 218 based on operations stored in the memory storage hardware 220. At operation 602, the method 600 includes operating the magnetic field source 204 of the flow meter 200 to produce a first magnetic field 210 that at least partially interacts with conductive fluid 14 flowing through the conduit 102. The first magnetic field 210 induces eddy currents in the conductive fluid 14, resulting in a second magnetic field 212 experienced at the magnetic field source 204. For example, the magnetic field source 204 may include a permanent magnet that is linearly displaced by the second magnetic field 212, or the magnetic field source 204 may include an electromagnet where a current is induced in a winding of the electromagnet responsive to the second magnetic field 212. At operation 604, the method 600 includes generating sensor data 222 representative of the strength of the second magnetic field 212. At operation 606, the method 600 includes determining the flow rate F₁₄ of the conductive fluid 14 based on processing of the captured sensor data 222. Optionally, the method 600 includes calibrating the flow meter 200 based on physical characteristics and/or operating parameters of the conduit 102 and foundry system 100.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations including:
with a conductive fluid flowing through a conduit formed from a non-magnetic material, and with a flow meter positioned at or near the conduit and having a magnetic field source spaced from the conduit and producing a first magnetic field that at least partially interacts with the conductive fluid flowing through the conduit, generating sensor data representative of strength of a second magnetic field at least partially interacting with the flow meter, the second magnetic field produced by eddy currents induced in the conductive fluid by the first magnetic field; and
based on processing of the generated sensor data representative of strength of the second magnetic field, determining a flow rate of the conductive fluid through the conduit.

2. The method of claim 1, wherein the magnetic field source further includes a housing and a biasing element between the magnetic field source and the housing, the second magnetic field causing movement of the magnetic field source toward the biasing element and the housing, and a linear displacement sensor generating the sensor data representative of strength of the second magnetic field based on movement of the magnetic field source relative to the biasing element and the housing.

3. The method of claim 1, wherein an array of load sensors engaging the magnetic field source generate the sensor data representative of strength of the second magnetic field.

4. The method of claim 1, wherein the magnetic field source includes a permanent magnet.

5. The method of claim 1, wherein the magnetic field source includes an electromagnet.

6. The method of claim 5, wherein the electromagnet includes a first wire coil and a second wire coil, the first wire coil electrically charged to produce the first magnetic field, and the second magnetic field inducing current in the second wire coil, the sensor data representative of strength of the second magnetic field generated based on the current induced in the second wire coil.

7. The method of claim 5, wherein the operations further include electrically charging the electromagnet to produce the first magnetic field.

8. The method of claim 7, wherein electrically charging the electromagnet includes at least one selected from the group consisting of (i) using DC electrical current and (ii) using AC electrical current.

9. The method of claim 1, wherein the operations further include determining a calibration profile based on processing of the generated sensor data representative of strength of the second magnetic field and known flow rates of the conductive fluid through the conduit.

10. The method of claim 1, wherein the conductive fluid includes molten aluminum, the conduit delivering the conductive fluid to a casting mold for a vehicular component.

11. A system comprising:
a flow meter positioned at or near a conduit formed from a non-magnetic material, the flow meter having a magnetic field source;
data processing hardware; and
memory hardware in communication with the data processing hardware, the memory hardware storing instructions that, when executed on the data processing hardware, cause the data processing hardware to perform operations including:
with a conductive fluid flowing through the conduit, and with the magnetic field source spaced from the conduit and producing a first magnetic field that at least partially interacts with the conductive fluid flowing through the conduit, generating sensor data representative of strength of a second magnetic field at least partially interacting with the flow meter, the second magnetic field produced by eddy currents induced in the conductive fluid by the first magnetic field; and
based on processing of the generated sensor data representative of strength of the second magnetic field, determining a flow rate of the conductive fluid through the conduit.

12. The system of claim 11, wherein the magnetic field source further includes a housing and a biasing element between the magnetic field source and the housing, the second magnetic field causing movement of the magnetic field source toward the biasing element and the housing, and a linear displacement sensor generating the sensor data representative of strength of the second magnetic field based on movement of the magnetic field source relative to the biasing element and the housing.

13. The system of claim 11, wherein an array of load sensors engaging the magnetic field source generate the sensor data representative of strength of the second magnetic field.

14. The system of claim 11, wherein the magnetic field source includes a permanent magnet.

15. The system of claim 11, wherein the magnetic field source includes an electromagnet.

16. The system of claim 15, wherein the electromagnet includes a first wire coil and a second wire coil, the first wire coil electrically charged to produce the first magnetic field, and the second magnetic field inducing current in the second wire coil, the sensor data representative of strength of the second magnetic field generated based on the current induced in the second wire coil.

17. The system of claim 15, wherein the operations further include electrically charging the electromagnet to produce the first magnetic field.

18. The system of claim 17, wherein electrically charging the electromagnet includes at least one selected from the group consisting of (i) using DC electrical current and (ii) using AC electrical current.

19. The system of claim 11, wherein the operations further include determining a calibration profile based on processing of the generated sensor data representative of strength of the second magnetic field and known flow rates of the conductive fluid through the conduit.

20. The system of claim 11, wherein the conductive fluid includes molten aluminum, the conduit delivering the conductive fluid to a casting mold for a vehicular component.
